(19) United States
(12) Patent Application Publication
(10) Pub. No.: US 2025/0390513 A1
(43) Pub. Date: Dec. 25, 2025

(54) Systems and methods for locating, cataloguing, and displaying information-rich graphics

(71) Applicant: Raphael Farzan-Kashani, Great Neck, NY (US)

(72) Inventor: Raphael Farzan-Kashani, Great Neck, NY (US)

(21) Appl. No.: 18/831,063

(22) Filed: May 23, 2024

Related U.S. Application Data
(60) Provisional application No. 63/577,883, filed on May 31, 2023.

(51) Int. Cl. G06F 16/28

(52) U.S. Cl. CPC G06F 16/287

(57) ABSTRACT

A system for locating, cataloguing, and displaying information-rich graphics is disclosed. The system comprising: computing devices configured with a computer application; and a user interface established in the computing devices. A storage medium, coupled to a processor. The processor enables the system to: receive user inputs from of the computing devices; parse the inputs to identify textual content, media content. The processor is further configured to: fetch content attributes from data sources based on the identified textual content and the media content. Further, the fetched content attributes are analyzed for cataloguing the content attributes into categories. The catalogued content attributes is further classified into dataset based on score. The processor enables the system to: generate information-rich graphics by encoding the classified content attributes into a multimodal embedding; and display the generated information-rich graphics on the user interface established in the computing device using the computer application.

### CROSS-REFERENCE TO RELATED APPLICATION

This application claims the benefit of U.S. Provisional Patent Application Ser. No. 63/577,883, filed on May 31, 2023, titled “SYSTEM AND METHODS FOR LOCATING, CATALOGUING, AND DISPLAYING INFORMATION-RICH GRAPHICS”, the entire content of which is hereby incorporated by reference in its entirety.

### BACKGROUND

### Field of Invention

Embodiments disclosed herein relate, in general, to systems and methods for visualizing information and, more particularly, to systems and methods for locating, cataloguing, and displaying information-rich graphics.

### Description of Related Art

Data visualizations, diagrams, and cartographic displays are ubiquitous modes of communication in today's web and digital workplace. These graphics serve as valuable resources for professionals, researchers, and general public. They provide evidence-based answers to specific questions, compare entities and events across specific dimensions, and contain important contextual information on research findings via format, structure, and design (also known as “visual semantics”). Moreover, they reveal references to meaningful sources of expertise and intelligence for deeper analysis and exploration.

Despite the significance of data visualizations, diagrams, and cartographic displays, there is currently no unified system or user interface for efficiently retrieving, cataloguing, presenting, and navigating large numbers of graphics from extensive databases of images, documents, and applications. These types of graphics embed text within images, reside deep within reports (e.g., PDF reports), videos, and presentations, or remain encoded in HTML and dynamic JavaScript-powered web applications.

However, conventional search engines do not offer comprehensive solutions for crawling, classifying, indexing, and retrieving these types of graphics at scale. Moreover, users of social networking applications cannot easily share, distribute, or filter for the specific type of content. As a result, users seeking comparative statistics or authoritative evidence for an analysis face significant cognitive burdens. The users have to spend considerable time triaging through search engine results or web links shared on social media platforms, which further require them to open and review lengthy documents, conduct multiple follow-on searches, and validate various sources and references before arriving at a relevant document, dataset, or source of expertise. Because most of these documents are not connected via hyperlinked citations, information networks are traversed manually by the user.

FIG. 1 illustrates a user interface of a traditional search engine 100. The traditional search engine 100 provides static image-based results for a user query. The traditional search engine 100 further provides unorganized text-based results. Additionally, the traditional search engine 100 lacks features such as, but not limited to, sorting of the search results, filtering of the search results, organizing the search results, and so forth. Further, duplicate or near-duplicate search results are provided by the traditional search engine 100.

As shown in the FIG. 1, a user submits a query to a conventional search engine seeking a “map of the Ukraine war”. Initially, the user receives a list of links and textual snippets, with no ability to assess the quality of the results from a visual or functional perspective. When the user modifies the query to retrieve only image results, several serious limitations become apparent. First, there is limited recall, with only a restricted number of graphics being returned. For example, dynamic non-image-based maps, such as graphs embedded in applications or Hypertext Markup Language (HTML) documents are not included in the search results. Secondly, there is no clear provenance for the data embedded in each of the graphics. For example, although the website location is displayed alongside each graphic, there is no indication of the underlying source or actual publisher for each piece of graphic content. Further, there are deficiencies in precision, as there are inconsistencies in the quality of the search results. Some images lack proper titles, while other images are returned without their textual overlays. Furthermore, the search results cannot be ranked based on the quality or sorted information based on criteria such as a date, demographic area, and so forth. Further, duplicates and near duplicates search results are not consolidated or sorted in any way, such as by a date. Moreover, insufficient descriptions hinder the user's ability to assess the functionality or utility of a particular graphic. The conventional search engines do not provide any additional information that could aid in the customization of the graphics, such that a graphic is derived from an interactive data application.

Further, with a limited number of image search results, the user must resort to reviewing the broader set of textual links, which necessitates visiting multiple media directories and interfaces to locate the most relevant document, dataset, or a unit of information. Therefore, the conventional processes are inefficient, cumbersome, and time-consuming.

There is, therefore, a need for an advanced and improved system for locating, cataloguing, and displaying information-rich graphics that can address the above-mentioned limitations more effectively.

### SUMMARY

Embodiments in accordance with the present invention provide a system for locating, cataloguing, and displaying information-rich graphics. The system comprising: one or more computing devices, wherein the one or more computing devices are configured with at least one computer application. The system further comprising: at least one user interface established in the one or more computing devices using the at least one computer application. The system further comprising: at least one storage medium, coupled to at least one processor, the at least one storage medium comprising one or more executable by the at least one processor. The execution of the encoded one or more instructions enable the system to: receive one or more user inputs from at least one of the one or more computing devices; parse, using a machine learning algorithm, the one or more inputs to identify one or more textual content, one or more media content, or a combination thereof; fetch one or more content attributes from a plurality of data sources based on the identified one or more textual content, the one or more media content, or a combination thereof; analyze the fetched one or more content attributes to catalogue the one or more content attributes into one or more categories; classify each of the catalogued content attributes into at least one dataset based on at least one score; generate one or more information-rich graphics by encoding the at least one classified content attributes into a multimodal embedding; and display the one or more generated information-rich graphics on the at least one user interface established in the one or more computing device using the at least one computer application.

Embodiments in accordance with the present invention provide a system for locating, cataloguing, and displaying information-rich graphics. The system comprising: one or more computing devices, wherein the one or more computing devices are configured with at least one computer application. The system further comprising: at least one user interface established in the one or more computing devices using the at least one computer application. The system further comprising: at least one storage medium, coupled to at least one processor, the at least one storage medium comprising one or more executable by the at least one processor. The execution of the encoded instructions enables the system to: receive one or more user inputs from at least one of the one or more computing devices; parse, using a machine learning algorithm, the one or more inputs to identify one or more textual content, one or more media content, or a combination thereof; fetch one or more content attributes from a plurality of data sources based on the identified one or more textual content, the one or more media content, or a combination thereof; analyze the fetched one or more content attributes to catalogue the one or more content attributes into one or more categories, wherein the one or more fetched content attributes are catalogued for conducting a nearest neighbor search to perform at least one action on the one or more fetched content attributes; classify each of the catalogued content attributes into at least one dataset based on at least one score; generate one or more information-rich graphics by encoding the at least one classified content attributes into a multimodal embedding; and display the one or more generated information-rich graphics on the at least one user interface established in the one or more computing device using the at least one computer application.

Embodiments in accordance with the present invention provide a method for locating, cataloguing, and displaying information-rich graphics. The method comprising steps of: receiving one or more user inputs from at least one of the one or more computing devices; parsing, using a machine learning algorithm, the one or more inputs to identify one or more textual content, one or more media content, or a combination thereof; fetching one or more content attributes from a plurality of data sources based on the identified one or more textual content, the one or more media content, or a combination thereof; analyzing the fetched one or more content attributes to catalogue the one or more content attributes into one or more categories; classifying each of the catalogued content attributes into at least one dataset based on at least one score; generating one or more information-rich graphics by encoding the at least one classified content attributes into a multimodal embedding; and display the one or more generated information-rich graphics on the at least one user interface established in the one or more computing device using the at least one computer application.

Embodiments of the present invention may provide a number of advantages depending on its particular configuration. First, embodiments of the present application provide a system for locating, cataloguing, and displaying information-rich graphics.

Further, embodiments of the present application may provide a system for locating, cataloguing, and displaying information-rich graphics for interactive surfing on communication networks.

Furthermore, embodiments of the present application may provide a system for locating, cataloguing, and displaying information-rich graphics for searching results for users' queries on the communication networks.

Moreover, embodiments of the present application may provide a system for locating, cataloguing, and displaying information-rich graphics for continuous updating of information-rich graphics in real-time.

Additionally, embodiments of the present application may provide a system for locating, cataloguing, and displaying information-rich graphics for audio-visual exchange of information over the communication networks.

Embodiments of the present application may further provide a system for locating, cataloguing, and displaying information-rich graphics for an organization's intranet or private document corpus.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates a user interface of a traditional search engine;

FIG. 2 illustrates a block diagram of a system for locating, cataloguing, and displaying information-rich graphics, according to embodiments of the present invention disclosed herein;

FIG. 3A illustrates a block diagram of a storage medium of the system, according to embodiments of the present invention disclosed herein;

FIG. 3B illustrates a set of operations for visualizing and interacting with the information-rich graphics, according to embodiments of the present invention disclosed herein;

FIG. 4 illustrates a method for generating the information-rich graphics, according to embodiments of the present invention disclosed herein;

FIG. 5 illustrates a method for parsing received inputs, according to embodiments of the present invention disclosed herein;

FIG. 6 illustrates a method for fetching of content attributes from the received inputs, according to embodiments of the present invention disclosed herein;

FIG. 7 illustrates a dataflow of the system, according to embodiments of the present invention disclosed herein;

FIG. 8 illustrates a listing depicting various types of the information-rich graphics, according to embodiments of the present invention disclosed herein;

FIG. 9A illustrates a user interface provided to a user, according to an embodiment of the present invention disclosed herein;

FIG. 9B illustrates the user interface with information-rich graphics, according to another embodiment of the present invention disclosed herein;

FIG. 10A and FIG. 10B illustrate an exemplary representation of the information-rich graphics, according to embodiments of the present invention disclosed herein;

FIG. 11A and FIG. 11B illustrate a layout of information-rich graphics embedded in a document, according to an embodiment of the present invention disclosed herein;

FIG. 12A and FIG. 12B illustrate the layout and attributes of the information-rich graphic provided on the user interface, according to embodiments of the present invention disclosed herein;

FIG. 13 illustrates a layout of the user interface for displaying a large number of the information-rich graphics, according to embodiments of the present invention disclosed herein;

FIG. 14 illustrates the user interface with the information-rich graphics, according to another exemplary embodiment of the present invention disclosed herein; and

FIG. 15 illustrates an exemplary user interface of the system, according to embodiments of the present invention disclosed herein.

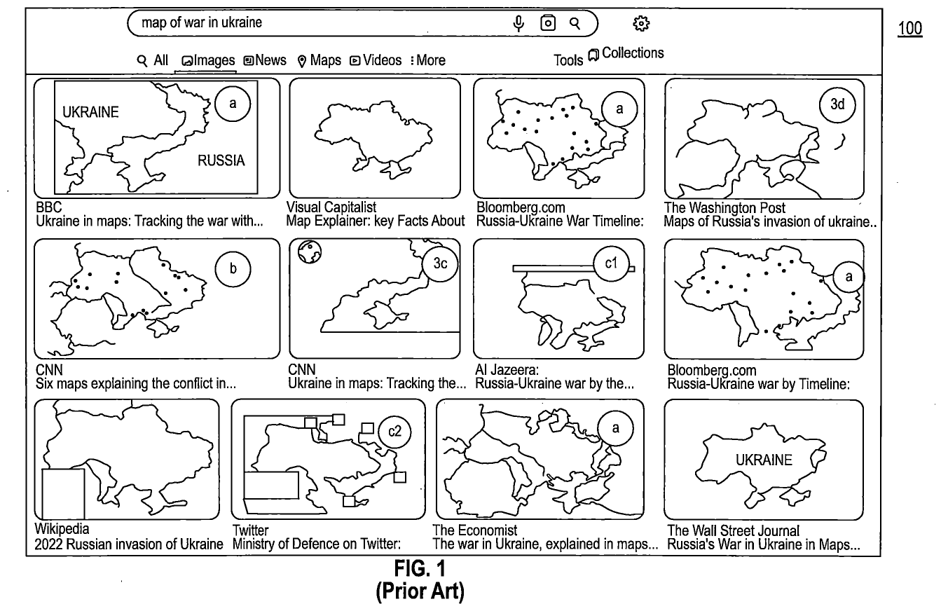

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modifications, equivalents, and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be described below in conjunction with an exemplary system for locating, cataloguing, and displaying information-rich graphics. Embodiments of the present invention are not limited to any particular type of the system for locating, cataloguing, and displaying information-rich graphics. Those skilled in the art will recognize the disclosed techniques may be used in any information-retrieval or information-sharing system in which it is desirable for locating, cataloguing, and displaying information-rich graphics.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

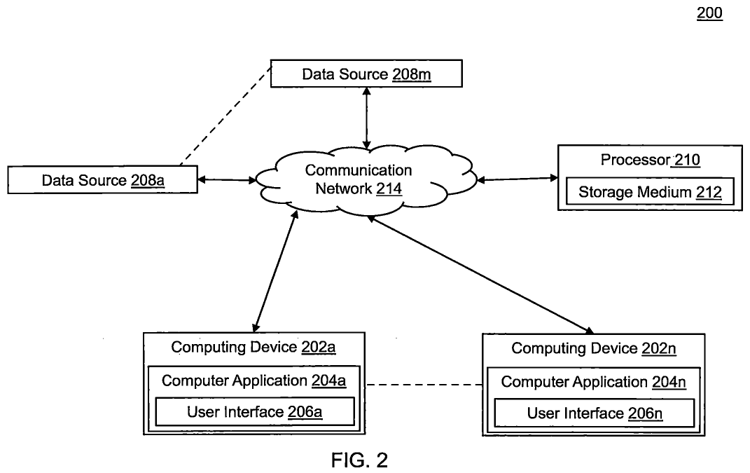

FIG. 2 illustrates a block diagram of a system 200 for locating, cataloguing, and displaying information-rich graphics, according to embodiments of the present invention. The system 200 may be capable of locating, and cataloguing search results received from various data sources, which are associated with one or more queries. Further, the system 200 may be capable of converting the search results into information-rich graphics.

The system 200 may encompass various components and functionalities to facilitate an efficient retrieval, organization, and presentation of the information-rich graphics. The system 200 may further comprise functionalities to display the information-rich graphics to users in a user-friendly manner. The system 200 may enable a rendering and presentation of the information-rich graphics, ensuring optimal visibility and clarity for the users to engage with the content effectively. Additionally, the system 200 may incorporate various algorithms and techniques to enhance the search and navigation experience for the users. The system 200 may enable efficient indexing and retrieval of the information-rich graphics, facilitating quick and accurate access to relevant visuals and information.

According to an embodiment of the present invention, the system 200 may comprise a plurality of computing devices 202a-202n (hereinafter referred to as the computing device 202). The computing device 202 may further comprise a plurality of computer application 204a-204n (hereinafter referred to as the computer application 204), such that each of the computer applications 204 may be provided with a user interface 206, in an embodiment of the present invention.

In an embodiment of the present invention, the computing device 202 may be a device utilized by a user to interact with the system 200. In an embodiment of the present invention, the computing device 202 may enable the user to provide inputs to the system 200. The computing device 202 may further return with search results to the user based on the inputs provided by the user, in an embodiment of the present invention. The computing device 202 may be, but not limited to, a personal computer, a laptop, a smartphone, a tablet, and so forth. Embodiments of the present invention are intended to include or otherwise cover any type of the computing device 202 including known, related art, and/or later developed technologies.

According to an embodiment of the present invention, the computing device 202 may comprise software applications such as, but not limited to, a search application, an image viewing application, a video viewing application, and the like. In a preferred embodiment of the present invention, the computing device 202 may comprise the computer application 204 that is voluntarily referred to as a “Giraffe platform”. The computer-readable program may be installed in the computing device 202 for executing functions associated with the system 200.

In an embodiment of the present invention, the user interface 206 of the computing device 202 may provide a human-machine communicable interface. The user interface 206 may enable the user to interact with the computing device 202, in an embodiment of the present invention.

In an embodiment of the present invention, the user interface 206 of the computing device 202 may be a Graphical User Interface (GUI). The Graphical User Interface (GUI) may display information related to the computer application 204 in a graphical representation on the computing device 202. According to embodiments of the present invention, the graphical representation may include elements such as, but not limited to, graphs, charts, bullet points, animations, links, and so forth. Embodiments of the present invention are intended to include or otherwise cover any graphical elements that may be utilized for information projection relating to the computer application 204, including known, related art, and/or later developed technologies.

In another embodiment of the present invention, the user interface 206 of the computing device 202 may be a Command Line Interface (CLI). The Command Line Interface (CLI) may display information related to the computer application 204 in a textual structured or semi-structured format.

In an embodiment of the present invention, the system 200 may comprise a plurality of data sources 208a-208m (hereinafter referred to as the data sources 208) that may be configured to provide information, based on the user inputs, to the system 200 for generation of the information-rich graphics. The system 200 may employ a web-crawler application that may be coded and configured to approach the data sources 208 for acquiring and scouting the information based on the user inputs, in an embodiment of the present invention. The data sources 208 may be for example, but not limited to, social media platforms, websites, latent information network, web archives, articles, publications, research paper, white-papers, media houses, patent applications, thesis, news houses, blogs, and so forth. Embodiments of the present invention are intended to include or otherwise cover any data sources 208, including known, related art, and/or later developed technologies, that may provide information to the system 200 for the generation of the information-rich graphics.

Further, the system 200 may comprise a processor 210 and a storage medium 212. The processor 210 may be configured to execute computer-readable instructions stored within the storage medium 212 to generate the information-rich graphics.

According to embodiments of the present invention, the processor 210 may be, but not limited to, a Programmable Logic Control (PLC) unit, a microprocessor, a development board, and so forth. Embodiments of the present invention are intended to include or otherwise cover any type of the processor 210 including known, related art, and/or later developed technologies.

In an embodiment of the present invention, the processor 210 may be connected to the computing device 202 and the storage medium 212 through a communication network 214. In another embodiment of the present invention, the processor 210 may be located on a cloud server (not shown). In an embodiment of the present invention, the cloud server may be remotely located. In an exemplary embodiment of the present invention, the cloud server may be a public cloud server. In another exemplary embodiment of the present invention, the cloud server may be a private cloud server. In yet another embodiment of the present invention, the cloud server may be a dedicated cloud server. According to embodiments of the present invention, the cloud server may be, but not limited to, a Microsoft Azure cloud server, an Amazon AWS cloud server, a Google Compute Engine (GCE) cloud server, an Amazon Elastic Compute Cloud (EC2) cloud server, and so forth. Embodiments of the present invention are intended to include or otherwise cover any type of the cloud server including known, related art, and/or later developed technologies.

Further, the computer application 204 may be installed on the cloud server alongside the processor 210, in an embodiment of the present invention. In an embodiment of the present invention, the computer application 204 may be installed on the storage medium 212 located on the computing device 202 of the user.

In an embodiment of the present invention, the storage medium 212 may be configured to store the computer-readable instructions executed by the processor 210. In an embodiment of the present invention, the storage medium 212 may be a non-transitory storage medium. In an embodiment of the present invention, non-limiting examples of the storage medium 212 may be a Read Only Memory (ROM), a Random-Access Memory (RAM), an Erasable Programmable Read Only Memory (EPROM), an Electrically Erasable Programmable Read Only Memory (EEPROM), a hard drive, a removable media drive for handling memory cards, and so forth. Embodiments of the present invention are intended to include or otherwise cover any type of the storage medium 212, including known, related art, and/or later developed technologies.

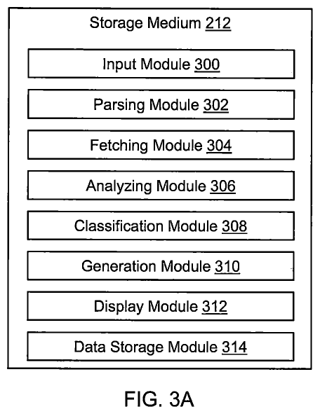

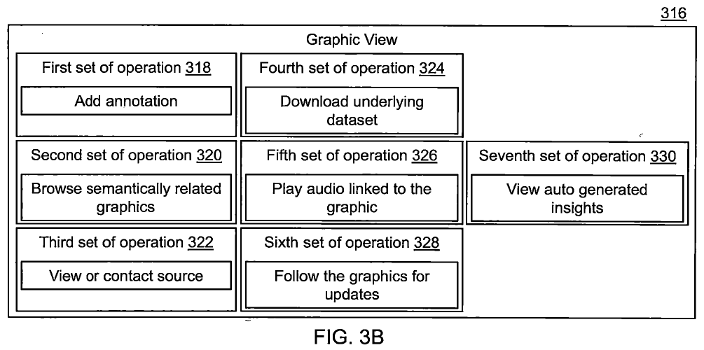

According to an embodiment of the present invention, the storage medium 212 may comprise electronic instructions readable by the computing device 202 in the form of modules. In an embodiment of the present invention, the storage medium 212 may further be explained in conjunction with FIG. 3A.

Further, the computing device 202, the data sources 208, and the processor 210 may be adapted to communicate using the communication network 214. According to embodiments of the present invention, the communication network 214 may be, but not limited to, a Wi-Fi communication network, a Bluetooth communication network, a millimeter waves communication network, an Ultra-High Frequency (UHF) communication network, a wired network and so forth. Embodiments of the present invention are intended to include or otherwise cover any type of the communication network 214, including known, related art, and/or later developed technologies.

FIG. 3A illustrates a block diagram of the storage medium 212 of the system 200, according to embodiments of the present invention. The storage medium 212 may comprise the computer-executable instructions in form of programming modules such as an input module 300, a parsing module 302, a fetching module 304, an analyzing module 306, a classification module 308, a generation module 310, a display module 312, and a data storage module 314.

In an embodiment of the present invention, the input module 300 may be configured to receive inputs from the computing device 202. In an embodiment of the present invention, the inputs may be received from the user. In another embodiment of the present invention, the inputs may be received from an automated script or a program. The inputs may be for example, but not limited to, a text, an audio input, images, webpages, reports, presentations, videos, photographs, computer screenshots, data applications, auxiliary documents in corpus, and so forth. Embodiments of the present invention are intended to include or otherwise cover any type of the inputs, including known, related art, and/or later developed technologies, that may be received by the computing device 202.

The input module 300 may further be configured to transmit the received inputs to the parsing module 302, in an embodiment of the present invention.

In an embodiment of the present invention, the parsing module 302 may be configured to parse the received inputs. The received inputs may be parsed using a machine learning algorithm to identify a textual content, a media content, and so forth in the received inputs. According to embodiments of the present invention, the media content may be for example, but not limited to, images, graphs, maps, tables, audio file, a video file, and so forth. Embodiments of the present invention are intended to include or otherwise cover any media content, including known, related art, and/or later developed technologies, that may be identified upon parsing of the received inputs. Further, the identified textual content and the media content may be passed to the fetching module 304.

Further, the parsing module 302 may be configured to retrieve a contextual understanding from the parsed inputs, in an embodiment of the present invention. The contextual understanding may enable the system 200 to understand requirements of the user from the inputs. In an exemplary scenario, if an input of the user may be ‘provide a line graph for sales on electric vehicle in Europe’, then the parsing module 302 may be configured to parse the input to contextually understand that user is querying for ‘line graph’ with ‘sales of electric vehicle’ and only in ‘European region’. This contextual understanding may enable the system 200 to eliminate search results comprising information rich-graphs that may not be ‘line graph’ or may not be representing ‘sales of electric vehicle’ or may not be specific to ‘European region’.

In an embodiment of the present invention, the fetching module 304 may be configured to fetch content attributes from the data sources 208 based on the identified textual content and the media content. In an embodiment of the present invention, the fetched content attributes may be search results that may be fetched from the one or more data sources 208 based on the inputs. The search results may include, but not limited to, an image, a bar graph, a video file, a weblink, a Uniform Resource Locator (URL), and so forth. In another embodiments of the present invention, the content attributes may be for example, but not limited to, a topic, an author, a publisher, a source, a question, a timeframe, an event, a metric, named entities, company names, geographies, a data visualization, and so forth. Embodiments of the present invention are intended to include or otherwise cover any content attributes, including known, related art, and/or later developed technologies, that may be fetched from the data sources 208.

In an embodiment of the present invention, the analyzing module 306 may be configured to analyze the fetched content attributes. The analysis of the fetched content attributes by the analyzing module 306 may further be configured to enable cataloguing of the content attributes into one or more categories, in an embodiment of the present invention.

The analyzing module 306 may be configured to catalogue the fetched content attributes into the one or more categories for conducting a nearest neighbor search on the fetched content attributes. The nearest neighbor search may perform a set of actions on the fetched content attributes. The actions may be such as, but not limited to, removal of duplicates, merging of near similar content attributes, and so forth. Embodiments of the present invention are intended to include or otherwise cover any actions, including known, related art, and/or later developed technologies, that may be performed on the fetched content attributes using the nearest neighbor search.

According to embodiments of the present invention, the catalogue for the classification of the fetched content attributes may be, but not limited to, a map catalogue, a graph catalogue, a table catalogue, a text catalogue, a media catalogue, and so forth. Embodiments of the present invention are intended to include or otherwise cover any other categories, including known, related art, and/or later developed technologies, in which the fetched content attributes may be catalogued.

In an embodiment of the present invention, the classification module 308 may be configured to generate a score for each of the catalogued content attribute. The score may be generated based on characteristics of the content attributes. The characteristics may be for example, but not limited to, visual cues, textual cues, structural cues, a quality of the content attributes, relevancy of the content attributes, and so forth. Embodiments of the present invention are intended to include or otherwise cover any characteristics of the content attributes, including known, related art, and/or later developed technologies, that may lead to generation of the score.

In an embodiment of the present invention, the classification module 308 may be configured to classify the catalogued content attributes into one or more datasets based on the generated score of each of the catalogued content attributes.

Further, the classification module 308 may be configured to select the catalogued content attributes with a high score, as compared to the catalogued content attributes with a low score, for generation of the information-rich graphics. In the above exemplary scenario, the classification module 308 may generate a higher score “1” for a dataset having information related to “Europe”, generate a lower score “2” for a dataset having information related to “Asia” and generate a lower score “5” for a dataset having information related to “Africa”.

In an embodiment of the present invention, the classification module 308 may further be configured to sub-classify the inputs, the media content, the textual content, the content attribute, and so forth, into one of an eligible class or an ineligible class. In an exemplary scenario, the classification module 308 may be configured to sub-classify the inputs, the media content, the textual content, the content attribute, and so forth, into the eligible class when the generated score is higher. In case, the generated score is lower, then the classification module 308 may be configured to sub-classify the inputs, the media content, the textual content, the content attribute, and so forth, into the ineligible class.

In an embodiment of the present invention, the inputs, the media content, the textual content, the content attribute, and so forth, sub-classified into the eligible class may be used for the generation of the information-rich graphics.

In an embodiment of the present invention, the generation module 310 may be configured to receive the classified content attribute having a higher score and may be sub-classified into the eligible class. Further, the generation module 310 may be configured to generate the information-rich graphics by encoding the received content attributes into multimodal embedding. The multimodal embedding may be defined as a blank template that may accommodate the received content attributes for generation of the information-rich graphics. Further, the information-rich graphics may comprise a singularity of the classified content attributes, in an embodiment of the present invention. In another embodiment of the present invention, the information-rich graphics may comprise a plurality of the classified content attributes. In yet another embodiment of the present invention, the multimodal embedding may be generated by encoding of the content attributes into a high-dimensional vector space. The high-dimensional vector space may be a drawing space where the information-rich graphics may be generated. The high-dimensional vector space may further enable generation of the information-rich graphics that may be greater than three-dimensions.

Further, the generation module 310 may be configured to generate dynamic control options on the information-rich graphics. The dynamic control options may enable the user to modify and/or customize the information-rich graphics as per the requirement. In the above exemplary scenario, the generation module 310 may be configured to generate the dynamic control options to select one or more countries within Europe to search for the sales of electric vehicles. The user may select “Germany” or “France” to view the sales of the electric vehicles.

Further, the generation module 310 may be configured to enable the user to manually generate the information-rich graphics using the content attributes. In an exemplary scenario, the user may select one of the multimodal embeddings and may manually place the content attributes within the selected multimodal embedding to generate the information-rich graphics.

In an embodiment of the present invention, the display module 312 may be configured to display the generated information-rich graphics on the user interface 206 established in the computing device 202 using the computer application 204. Further, the display module 312 may be configured to display multiple generated information-rich graphics and may further enable the user to select one of the displayed information-rich graphics, as per the requirement.

In an embodiment of the present invention, the data storage module 314 may be configured to store the displayed information-rich graphics on the computing device 202 using the computer application 204. In an embodiment of the present invention, the data storage module 314 may be configured to store the displayed information-rich graphics in one or more databases (not shown). In an embodiment of the present invention, the data storage module 314 may be configured to store the displayed information-rich graphics in the storage medium 212.

FIG. 3B illustrates a set of operations 316 provided to the user for visualizing, broadcasting, and interacting with the information-rich graphics, according to embodiments of the present invention. In an embodiment of the present invention, the input module 300 may be configured to enable the user to perform the set of operations 316 on the generated information-rich graphics.

In an embodiment of the present invention, the user may be a publisher who may publish, broadcast, or share the information-rich graphics on one or more platforms, such as, but not limited to, a social media platform, newspapers, blogs, and so forth.

In an embodiment of the present invention, a first set of operations 318 provided to the user may enable the user to add an annotation and/or a comment. The user may tag the comment with a particular portion in the information-rich graphics, in an embodiment of the present invention. In an exemplary scenario, the user may further provide the comment in the form of an audio clip and may tag the audio clip along with a particular portion in the information-rich graphics.

In an embodiment of the present invention, a second set of operations 320 provided to the user may include selecting to browse semantically one or more information-rich graphics that are related to the information-rich graphics displayed on the user interface 206 on the computing device 202. In an exemplary scenario, the user may select to view a compilation of semantically related information-rich graphics. The compilation of semantically related information-rich graphics may be the information-rich graphics comprising, but not limited to, similar content, addressing similar questions, or visually similar graphics, and so forth.

In another exemplary scenario, the user may further select to view a compilation of the information-rich graphics tagged with the same data sources 208 referenced in the displayed information-rich graphics. In another embodiment of the present invention, the user may be able to select to view previous or future versions of the displayed information-rich graphics. In some embodiments of the present invention, the previous versions of the information-rich graphics were uploaded by the publisher, the user or an author to the computer application 204. In other embodiments of the present invention, the previous versions of the information-rich graphics may have been identified, indexed, and automatically assembled into a chronological sequence by the computer application 204.

In an embodiment of the present invention, a third set of operations 322 provided to the user may include displaying additional information about the underlying data sources 208 of the information-rich graphics. In an exemplary scenario, when the user may hover over a segment of the information-rich graphics, additional data associated with the information-rich graphics may be displayed.

In an embodiment of the present invention, a fourth set of operations 324 provided to the user may include an opportunity to purchase the information-rich graphics and/or any data product related to the information-rich graphics or to contact the source of the information-rich graphics via a marketplace provided to the user by the computer application 204.

In an embodiment of the present invention, a fifth set of operations 326 provided to the user may include linking or playing back a descriptive audio published and linked to the current information-rich graphics by a publisher.

In an embodiment of the present invention, a sixth set of operations 328 provided to the user may include an option for getting notified in a real-time, corresponding to the changes in the information-rich graphics by the publisher, recommendations received from one or more other users for the generated information-rich graphics or when the changes are detected by the computer application 204.

In another embodiment of the present invention, the user may select to receive notifications on related updates to the information-rich graphics, and updates to the underlying dataset of the content attributes. For example, if the system 200 may fetch a new information-rich graph related to the user input, then the system 200 may score it as “1” and may provide an update to the user regarding the new information-rich graph.

In yet another embodiment of the present invention, the user may select to receive real-time notifications on near-identical information-rich graphics that are automatically identified by the computer application 204.

In an embodiment of the present invention, a seventh set of operations 330 provided to the user may be deploying methods of natural-language processing to auto-generated insights based on the displayed information-rich graphics. In such an embodiment of the present invention, the user may select to generate or review the insights in addition to those insights offered directly by the publisher or those insights offered by other users via comments.

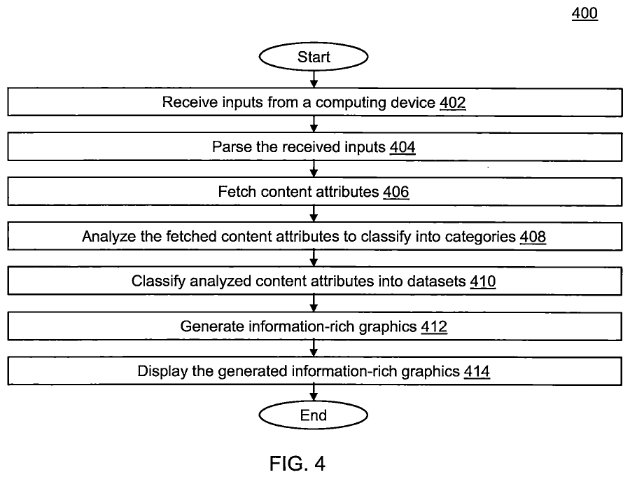

FIG. 4 illustrates a method 400 for generating the information-rich graphics, according to embodiments of the present invention.

At step 402, the system 200 may receive inputs from the computing device 202.

At step 404, the system 200 may use the machine learning algorithm to parse the inputs to identify the textual content, the media content, and so forth, in the received inputs, as discussed above.

At step 406, the system 200 may fetch the content attributes from the data sources 208 based on the identified textual content, the identified media content, and so forth.

At step 408, the system 200 may analyze the fetched content attributes to catalogue the content attributes into the categories.

At step 410, the system 200 may classify the catalogued content attributes into the dataset based on a generated score. The score may be generated based on the characteristics of the content attributes, as discussed above.

At step 412, the system 200 may generate the information-rich graphics by encoding the classified content attributes into the multimodal embedding.

Further, at step 414, the system 200 may display the generated information-rich graphics on the user interface 206 established in the computing device 202 using the computer application 204.

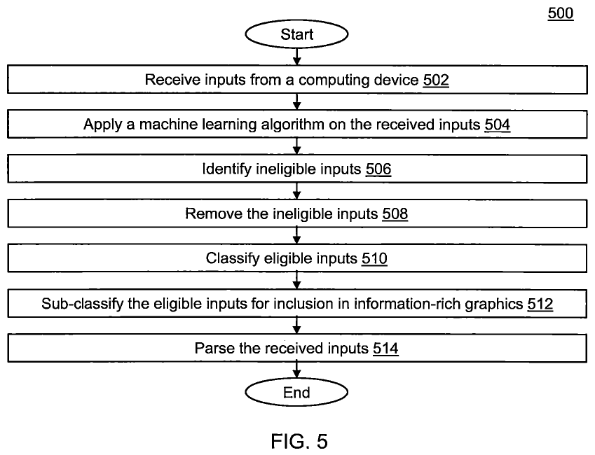

FIG. 5 illustrates a method 500 for parsing the received inputs, according to embodiments of the present invention.

At step 502, the system 200 may receive inputs from the computing device 202.

At step 504, the system 200 may apply the machine learning algorithm on the received inputs.

At step 506, the system 200 may utilize the machine learning algorithm to identify ineligible inputs from the received inputs. The ineligible inputs may be but not limited to, a repetitive word, an alphanumeric string, misspelled words, and so forth.

At step 508, the system 200 may remove the identified ineligible inputs.

At step 510, the system 200 may classify eligible inputs based on the contextual understating of the received inputs.

At step 512, the system 200 may sub-classify the eligible inputs for inclusion in the information-rich graphics.

At step 514, the system 200 may use the machine learning algorithm to parse the received eligible only inputs.

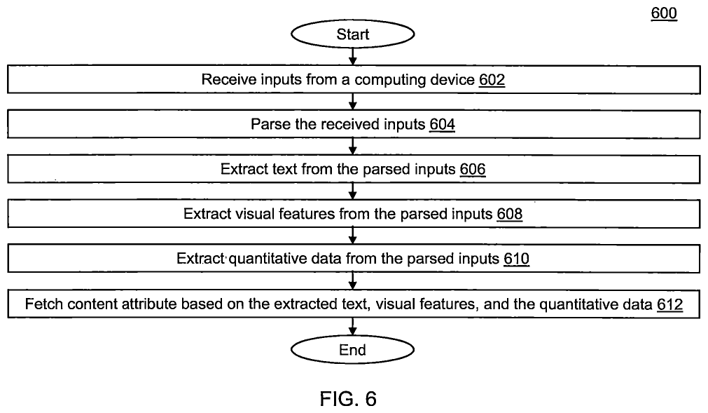

FIG. 6 illustrates a method 600 for fetching of content attributes, according to embodiments of the present invention.

At step 602, the system 200 may receive inputs from the computing device 202.

At step 604, the system 200 may use the machine learning algorithm to parse the inputs to identify the textual content, the media content, and so forth, in the received inputs.

At step 606, the system 200 may extract text from the parsed inputs.

Further, at step 608, the system 200 may extract visual features from the parsed inputs. The visual features may be for example, but not limited to, a shape, a color, a font, a pattern, and so forth.

Furthermore, at step 610, the system 200 may extract quantitative data from the parsed inputs. The quantitative data may be for example, a matrix, based on which the information-rich graphs may be generated.

At step 612, the system 200 may fetch the content attributes from the extracted text, the extracted visual feature, the extracted quantitative data, and so forth.

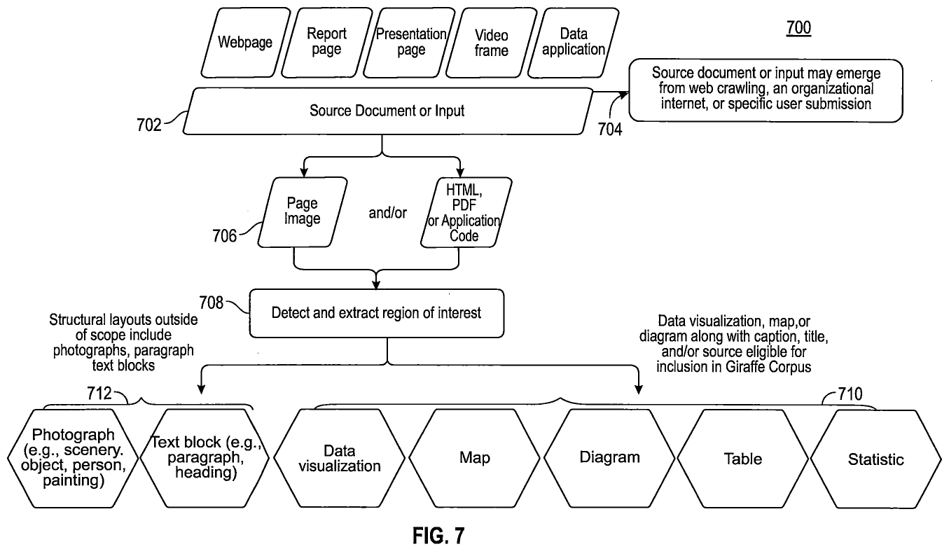

FIG. 7 illustrates a dataflow 700 of the system 200, according to embodiments of the present invention. In an embodiment of the present invention, the dataflow 700 may enable the system 200 to detect, locate, and distinguish data-driven graphics, maps, and figures from other types of images, documents, and document components.

At stage 702, the system 200 may receive an input, or a source document as an input, in the form of a webpage, a page from a report document, a page from a presentation document, a frame from a video presentation, or a frame from an interactive data application, and so forth. Embodiments of the present invention are intended to include or otherwise cover any type of the input that may be received by the system 200, including known, related art, and/or later developed technologies.

At stage 704, the system 200 may receive the source document or the inputs via crawling a website across the world wide web, in an embodiment of the present invention. The source document or the inputs may be provided by the user via the user interface 206, in an embodiment of the present invention. In other embodiments of the present invention, the inputs may be retrieved from an organization's intranet.

At stage 706, the system 200 may receive the source document or the inputs as an image, a compilation of code that may be a Hypertext Markup Language (HTML), or a combination thereof. In some embodiments of the present invention, if the source document or the inputs provided may be an image of a document page, then the system 200 may determine a class of the input. The class of input may be based on a type or a source of the input such as whether a submission of the input is an image of a page from a website, a report or presentation, a video frame, a photograph, a data application, a computer interface, and so forth. Embodiments of the present invention are intended to include or otherwise cover any class of the input that may be provided to the system 200, including known, related art, and/or later developed technologies.

At stage 708, upon successful submission of the source document or the inputs, the system 200 may locate one or more information-rich graphics or related regions of interest within the provided source document.

At stage 710, the system 200 may further determine whether a region of interest constitutes a structural component eligible for an inclusion in the computer application 204. In some embodiments of the present invention, the structural component may take the form of a data visualization, a map, a diagram, a table, and so forth. Embodiments of the present invention are intended to include or otherwise cover any form of the structural component that may be eligible for inclusion in the computer application 204, including known, related art, and/or later developed technologies.

At stage 712, the system 200 may structure add-on components that may not be included in a basic version of the computer application 204. The add-on components may enable the system 200 to understand context of the source document or the inputs, in an embodiment of the present invention. According to embodiments of the present invention, the structured add-on components may be, but not limited to, photographs, logos, hyperlinks, files, or text blocks such as titles, names, quantities, paragraphs, headings, captions, and citations. Embodiments of the present invention are intended to include or otherwise cover any add-on components that may enable the system 200 to understand the context of the source document or the inputs, including known, related art, and/or later developed technologies.

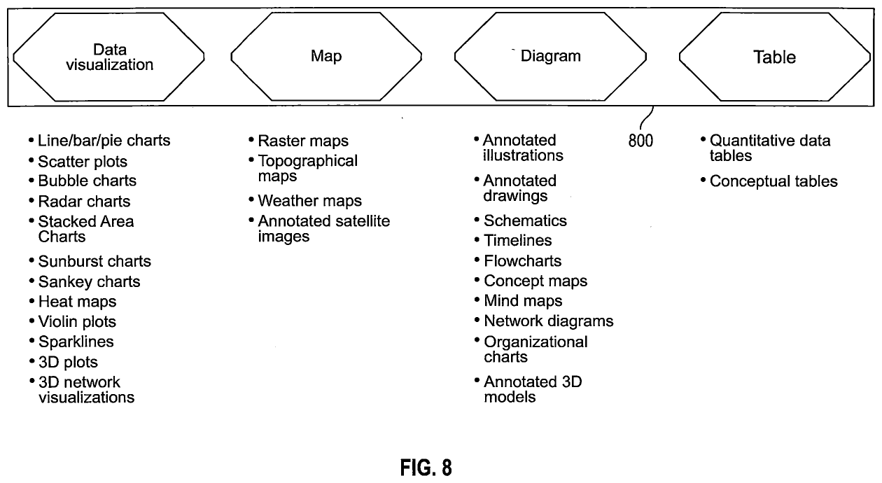

FIG. 8 illustrates a listing 800 depicting various types of the information-rich graphics, according to embodiments of the present invention. In an embodiment of the present invention, the information-rich graphics may include data visualizations, maps, diagrams, tables, and variations thereof.

According to embodiments of the present invention, the information-rich graphics may include data visualizations that may be, but not limited to, line charts, pie charts, bar charts, scattered plots, three-dimensional (3D) plots, 3D networks, and so forth. Embodiments of the present invention are intended to include or otherwise cover any type of the data visualizations for representing the information-rich graphics, including known, related art, and/or later developed technologies.

According to embodiments of the present invention, the information-rich graphics may include maps that may be, but not limited to, roaster maps, topological maps, physical maps, political maps, and so forth; including global, regional, national, sub-national, state, city, neighborhood, property maps, and so forth. Embodiments of the present invention are intended to include or otherwise cover any type of map for representing the information-rich graphics 904, including known, related art, and/or later developed technologies.

According to embodiments of the present invention, the information-rich graphics may include diagrams that may be, but not limited to, schematics, flowcharts, timelines, and so forth. Embodiments of the present invention are intended to include or otherwise cover any type of the diagrams for representing the information-rich graphics, including known, related art, and/or later developed technologies.

According to embodiments of the present invention, the information-rich graphics may include tables that may be, but not limited to, conceptual tables, quantitative tables, and so forth. Embodiments of the present invention are intended to include or otherwise cover any type of the tables for representing the information-rich graphics, including known, related art, and/or later developed technologies.

In some embodiments of the present invention, relevant graphics selected for inclusion may be designed to convey meaningful quantitative information across multiple dimensions. The quantitative information may consist of historical, projected, or forecasted data.

In other embodiments of the present invention, relevant graphics selected for inclusion may be designed to convey meaningful qualitative or conceptual information across multiple dimensions. For example, a comparative assessment of products and product features may be presented in a tabular format containing descriptive textual content.

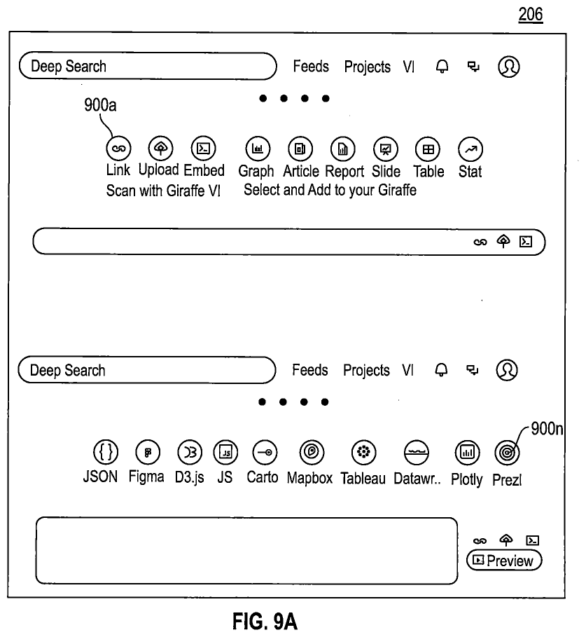

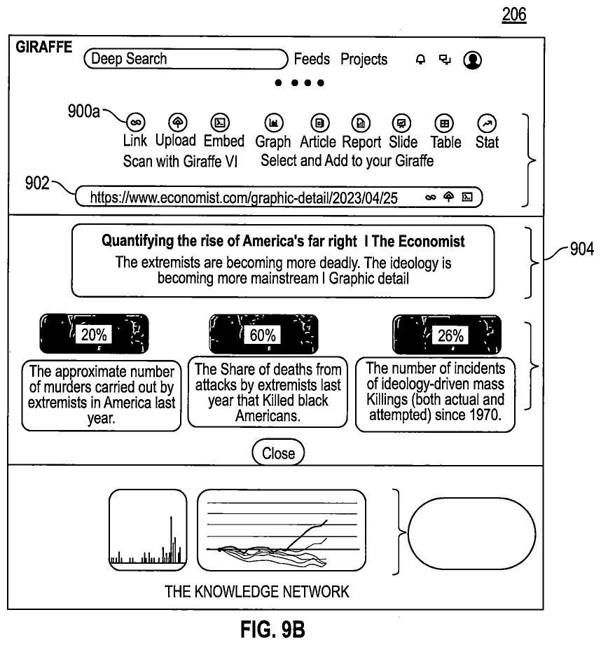

FIG. 9A illustrates the user interface 206 displayed on the computing device 202 to enable the user to submit inputs, according to embodiments of the present invention. In an embodiment of the present invention, action buttons 900a-900n may enable the user to navigate on the user interface 206. The action buttons 900a-900n may be triggered by a click or scrolling a cursor over the one or more action buttons 900a-900n. The action buttons 900a-900n may be classified into a set of front-end action buttons and a set of back-end action buttons.

According to an embodiment of the present invention, the action buttons 900a-900n in the set of front-end action buttons may be, but not limited to, a Link button, an Upload button, an Embed button, a Graph button, an Article button, a Report button, a Slide button, a Table button, a Stat button, so forth. Embodiments of the present invention are intended to include or otherwise cover any type of the action buttons 900a-900n that may underlie in the set of front-end action buttons, including known, related art, and/or later developed technologies.

According to an embodiment of the present invention, the action buttons 900a-900n in the set of back-end action buttons may be, but not limited to, a JSON button, a Figma button, a D2.js button, a JS button, a Carto button, a MapBox button, a Tableau button, a Datawrapper button, a Plotly button, a Prezi button, so forth. Embodiments of the present invention are intended to include or otherwise cover any type of the action buttons 900a-900n that may underlie in the set of front-end action buttons, including known, related art, and/or later developed technologies.

FIG. 9B illustrates the user interface 206 with the information-rich graphics, according to embodiments of the present invention. In an embodiment of the present invention, the user may be provided with an input field 902 for uploading of the source document or the inputs.

In an embodiment of the present invention, the system 200 may enable the user with the option to provide the input by using any of the action buttons 900a-900n, as discussed above.

In an exemplary embodiment of the present invention, the user may select the Link button from the action buttons 900a-900n in the set of front-end action buttons. Upon selecting the Link button, the user may input a web address in the input field 902. Further, the system 200 may analyze the provided web address and generate the information-rich graphics for the corresponding web address.

Similarly, in another exemplary embodiment of the present invention, the user may select the Figma button from the action buttons 900a-900n in the set of back-end action buttons. Upon selecting the Figma button, the user may upload “.fig” (Figma design) or “.jam” (FigJam) files from the computing device 202 into the input field 902. Further, the system 200 may analyze the “.fig” (Figma design) or “.jam” (FigJam) files and may further generate the information-rich graphics for the corresponding “.fig” (Figma design) or. “jam” (FigJam) files.

In an embodiment of the present invention, the system 200 may provide the users with the flexibility to input information through various means that may be, but not limited to, the option to submit links to web pages, documents, images containing a plurality of graphics, images of each of the graphics, and other compatible formats. Embodiments of the present invention are intended to include or otherwise cover any formats of the input that may be provided by the user to the system 200, including known, related art, and/or later developed technologies.

According to embodiments of the present invention, the provided source document may be of any format such as, but not limited to, a word processing document, a presentational document, a spreadsheet document, a portable formatted document, and so forth. Embodiments of the present invention are intended to include or otherwise cover any format of the document that may be provided by the user to the system 200, including known, related art, and/or later developed technologies.

According to embodiments of the present invention, the provided source document may be provided with a request by the user in the form of natural language, and the system 200 may return automatically generated information-rich graphics 904 using a large language model or the like. Embodiments of the present invention are intended to include or otherwise cover any form of generative artificial intelligence system that may be provided by the system 200, including known, related art, and/or later developed technologies.

The source document or the inputs may be uploaded from a local directory of the computing device 202, or a remote directory of the computing device 202, in an embodiment of the present invention.

In an embodiment of the present invention, the system 200 may enable the user to submit a compilation of code representing static or interactive graphics, such code may be derived from a qualified third-party entity that may generate information-rich graphics 904 and may generate a custom code to embed the information-rich graphics 904 on a separate web page.

Upon uploading the source document or the inputs, the system 200 may detect or generate one or more eligible information-rich graphics 904, further, the user may be presented with the information-rich graphics 904.

In an embodiment of the present invention, the system 200 may further present a set of auto generated metadata to the user. The user may be provided with an option to edit any portion of the set of auto generated metadata. The metadata may be incorporated to assist in the search-ability and discoverability of the information-rich graphics 904 within the user interface 206.

In an embodiment of the present invention, the user may further be presented with other quantitative information that may be extracted or generated from the submission, and suitable for inclusion in the information-rich graphics 904 provided on the user interface 206 of the computer application 204.

In an embodiment of the present invention, the system 200 may further provide an option to the user to select one or more information-rich graphics 904 for inclusion in a private collection, an organizational corpus, or for sharing in a publicly available compilation on the computer application 204.

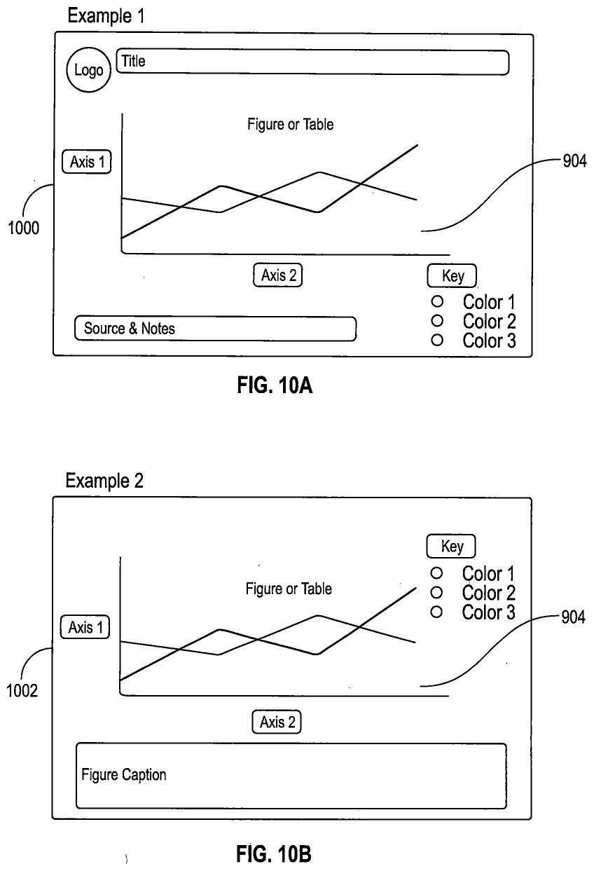

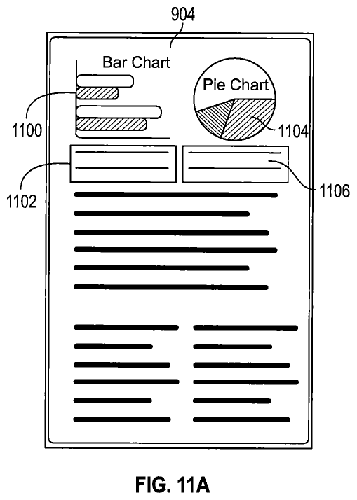

FIG. 10A illustrates a first graphical representation 1000 of an exemplary information-rich graphics 904, according to embodiments of the present invention. In an embodiment of the present invention, the first graphical representation 1000 in the information-rich graphics 904 may comprise a title. In such an embodiment of the present invention, the information-rich graphics 904 may comprise a set of two axes, along with a legend, a logo of a publishing entity, a title situated at a top of the information-rich graphics 904, and the data sources 208 situated at the bottom of the information-rich graphics 904.

FIG. 10B illustrates a second graphical representation 1002 of an exemplary information-rich graphics 904, according to embodiments of the present invention. In an embodiment of the present invention, the second graphical representation 1002 may contain a figure caption. In such an example of a qualifying information graphic (generally found in academic journal articles), the information-rich graphics 904 may comprise a set of two axes, along with a legend, and the title and description of the content are presented as a caption located at the bottom of the information-rich graphics 904.

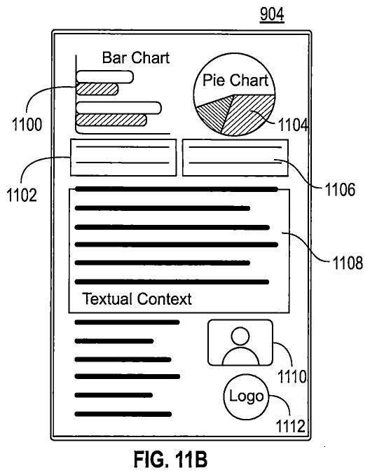

FIG. 11A illustrates a layout of the information-rich graphics 904 embedded in a document, according to embodiments of the present invention. In an embodiment of the present invention, the information-rich graphics 904 may feature a first figure “bar chart” 1100. The first FIG. 1100 may be accompanied by a first caption 1102, providing a brief description or explanation of the content depicted in the figure.

In another embodiment of the present invention, the information-rich graphics 904 may further feature a second figure “pie chart” 1104. The second FIG. 1104 may be accompanied by a second caption 1106, offering relevant details or additional information related to the content presented in the figure. The FIGS. 1100 and 1104 and captions 1102 and 1106 in the information-rich graphics 904, may work together to enhance the visual presentation and understanding of the information. By utilizing captions 1102 and 1106, the users may gain valuable context and insights into the content depicted in the FIGS. 1100, and 1104. In further embodiments of the present invention, other elements and formatting options may be incorporated to further enhance the information-rich graphics 904. Labels, annotations, color coding, or other visual aids may be included to provide additional context or emphasize specific details within the FIGS. 1100 and 1104. These features may contribute to an overall informative and visually engaging presentation, empowering the users to extract valuable insights from the information-rich graphics 904.

FIG. 11B illustrates an additional layout of the information-rich graphics 904 embedded in a document, according to embodiments of the present invention. In an embodiment of the present invention, the extensive layout of the information-rich graphics 904 may feature the first FIG. 1100, the first caption 1102, the second FIG. 1104, and the second caption 1106.

In some embodiments of the present invention, the source document or inputs may take the form of an article, or a page from a report document, or a page from a presentation document. In such embodiments of the present invention, the article or page may include the information-rich graphics 904, which may feature the first FIG. 1100 and the second FIG. 1104. Within this context, there may exist additional information that may be useful in understanding the context of the information-rich graphics 904, such as the first caption 1102 and the second caption 1106. By adopting the article or page format, the users may have access to a comprehensive presentation and contextual understanding of the information-rich graphics 904. The inclusion of the first caption 1102 and the second caption 1106 may provide descriptions or explanations that may complement the graphics and contribute to a deeper understanding of the depicted content. The article or page format and the accompanying captions may enable the users to gain a broader context and extract valuable insights from the information-rich graphics 904. By leveraging the potential presence of the first FIG. 1100 and the second FIG. 1104 within the article or page, the users may have access to a more comprehensive depiction of the information, further enhanced by the relevant captions. In an embodiment of the present invention, the extensive layout of the information-rich graphics 904 may provide textual content 1108 in the information-rich graphics 904 related to the first FIG. 1100 and the second FIG. 1104.

In some embodiments of the present invention, the textual content 1108 may take the form of a hyperlink and associated anchor text. In other embodiments of the present invention, the textual content 1108 may take the form of a textual snippet referring to the information-rich graphics 904 but without a hyperlink.

In an embodiment of the present invention, the extensive layout of the information-rich graphics 904 may further feature a name or photograph 1110 of the author and/or a contributor along with a logo 1112 of the author and/or contributor. The logo 1112 may be located within the vicinity of the information-rich graphics 904, serving as a visual representation or reference to identify the author and/or contributor of the adjacent graphics or the underlying data sources 208. The inclusion of the logo 1112 within the information-rich graphics 904 may enhance an overall presentation and may provide the users with valuable contextual information about the source and the origin of the depicted content.

In some embodiments of the present invention, the textual content 1108, whether containing textual or visual content, may be provided to a component classification system. The component classification system may apply natural language processing methods to identify the named entities (e.g., the names of individuals, the places, the entities, the organizations, and so forth), the quantities, the dates and timeframes, the related keywords, the topics, and concepts, and so forth.

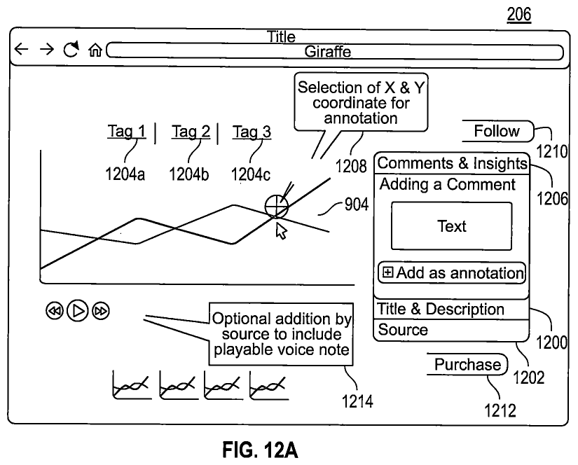

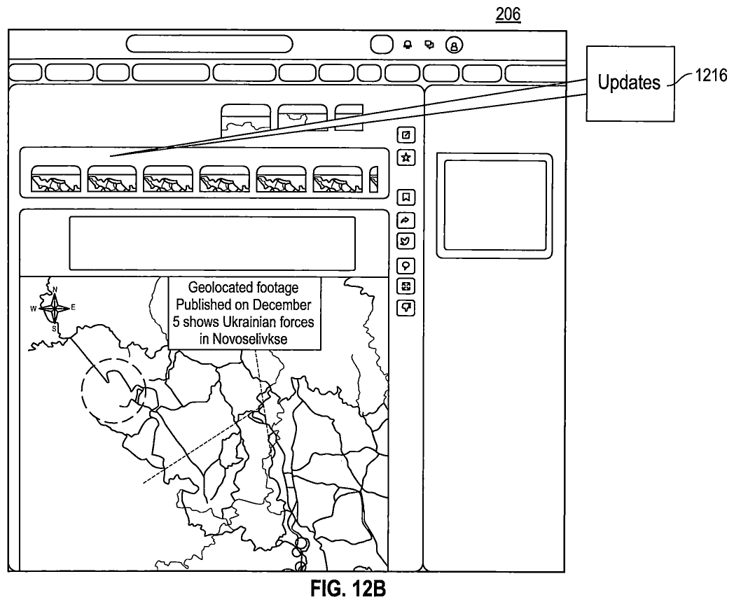

FIG. 12A illustrates the layout of one of the information-rich graphics 904 provided on the user interface 206, according to embodiments of the present invention.

In an embodiment of the present invention, while indexing and detecting the information-rich graphics 904, and components of the information-rich graphics 904, and other information located in the vicinity of the information-rich graphics 904, the component classification system, as described in the FIG. 11B, may identify and/or generate significant elements of metadata that may be useful to the user in understanding the meaning, relevance, or quality of the information-rich graphics 904.

In some embodiments of the present invention, the user interface 206 may comprise a tab to view “a title and/or description” 1200 of the information-rich graphic or the information-rich graphic's source documents.

Further, the metadata may include a name and/or a location 1202 of the underlying data sources 208 of the information-rich graphics 904.

Further, the metadata may include relevant keywords 1204a-1204c identified from the source documents and/or generated by the computer application 204.

In other embodiments of the present invention, the user interface 206 may comprise a tab “comments and insights” 1206 generated by the computer application 204 and/or by other the users of the computer application 204.

In other embodiments of the present invention, the user interface 206 may comprise a tab “comments and/or annotations” 1208 generated by other users of the computer application 204. In some embodiments of the present invention, the tab “comments and/or annotations” 1208 may be automatically generated by a large language model or alternative artificial intelligence system.

In some embodiments of the present invention, the system 200 may enable the user to annotate or interact with the information-rich graphics 904.

In some embodiments of the present invention, the system 200 may enable the user to follow updates 1210 for the displayed information-rich graphics 904.

In some embodiments of the present invention, the system 200 may enable the user to purchase 1212 underlying data or other content related to the information-rich graphics 904.

In some embodiments of the present invention, the user interface 206 may comprise a tab “to add or view additional information” 1214 related to the information-rich graphics 904. According to embodiments of the present invention, the add or view additional information 1214 may be, but not limited to, a text note, a voice note, alternative graphics, and so forth. Embodiments of the present invention are intended to include or otherwise cover any additional information 1214 that may be added related to the information-rich graphics 904, including known, related art, and/or later developed technologies.

FIG. 12B illustrates the user interface 206 for viewing one of the information-rich graphics 904, according to an exemplary embodiment of the present invention. The user may be presented with multiple metadata items to offer contextual information about the displayed information-rich graphics 904. These metadata items may include, but not limited to, the publisher, a title, a description, keywords, ability to comment on the information-rich graphics, and other related information-rich graphics sourced from the same document or other documents, among other possibilities, and so forth. By providing the metadata, the users may gain a better understanding of the graphics and their relevance, enabling them to make informed interpretations and engage with the content effectively. For example, the publisher metadata may indicate the source or entity responsible for creating or sharing the graphics, or the underlying data, helping the users to identify the origin or authority behind the information. The title metadata may provide a descriptive or informative title for the graphics, giving the users a summary or indication of the content depicted. The description metadata may offer a more detailed explanation or summary of the graphics, providing additional context, background information, or key insights. Further, the keyword metadata may consist of relevant terms or phrases associated with the graphics, aiding the users in quickly grasping the main topics or themes covered, facilitating searching and categorization, or navigating to related information graphics.

Additionally, the ability to comment metadata feature may allow the users to provide feedback, insights, recommendations, or ask questions about the information-rich graphics, encouraging engagement and facilitating discussion. Moreover, the metadata may include related information-rich graphics from the source document, providing links or references to other visuals that offer further context or a broader perspective. By incorporating these metadata items alongside the display of information-rich graphics, the system 200 may enhance the user's understanding by providing additional context and information, facilitating informed interpretations, consolidating variations of content, and promoting effective engagement with the content.

In certain scenarios, the user may have the option to view all previous and updated versions 1216 of the information-rich graphics 904 as a series, retrieved through a vector index of the high-dimensional vector space. The clustering and sequencing mechanism of the high-dimensional vector space may enable easy navigation and access to the various versions of the information-rich graphics 904 and may allow the user to explore evolving trends over the underlying data and other changes made to the information-rich graphics 904 over time.

In an embodiment of the present invention, the vector index may be employed by the system 200 to provide the users with a capability to explore and examine the evolution of an information-rich graphics 904 over the time. By utilizing the vector index, the users may be empowered with an option to navigate through multiple versions of information-rich graphics 904 in a structured and organized manner. Through the vector index, the system 200 may cluster and sequence the versions 1216 of the information-rich graphics 904, and may enable the users to track the changes made to the visuals and observe the progression. The vector index mechanism may facilitate an efficient comparison and identification of similarities and differences between the versions 1216, and may enhance the ability of the system 200 to present the information in a meaningful context.

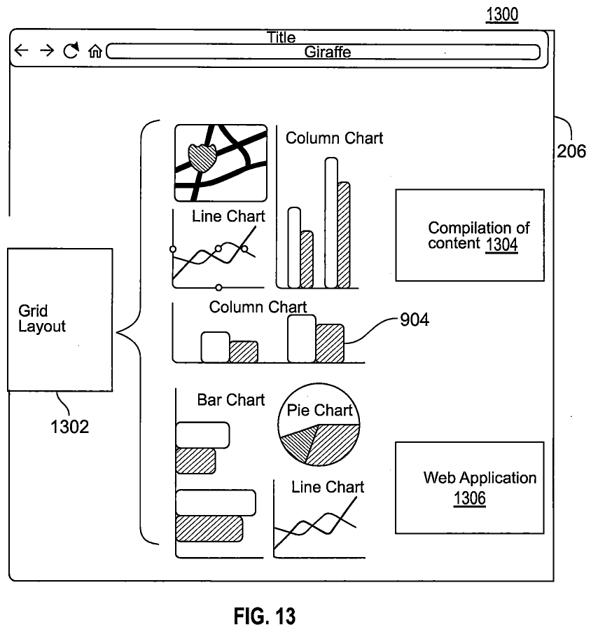

FIG. 13 illustrates a layout 1300 of the user interface 206 for displaying a large number of the information-rich graphics 904, according to embodiments of the present invention.

In an embodiment of the present invention, a Grid Layout 1302 may be used to efficiently combine information-rich graphics 904 of various sizes and classes, while maintaining legibility and minimizing the use of overall space on a display (not shown) of the computing device 202.

In an embodiment of the present invention, certain variables may be calculated by the Grid Layout 1302 during indexing and may be used to populate the grid layout or determine the position and/or size of each of the information-rich graphics 904 in the layout. Such variables may include the aspect ratio of graphics, the size of title and/or size of embedded text, quality of graphics, and so forth.

In an embodiment of the present invention, various compilations of these information-rich graphics 904 may be provided through the user interface 206. According to embodiments, of the present invention, the compilation of content 1304 may include, feeds such as, items from publishers and the other users followed by a particular user), items from a particular publisher or user, items citing a particular source, items related to a particular keyword or topic, results of a search query, items originating from a particular report, data application or dataset, items from a particular user's collection, items from a particular publisher sub-channel, items semantically related to a particular item, items related to a particular event, and so forth. The items may be for example, but not limited to, comments, reviews, likes, dislikes, ratings, recommendations, and so forth. Embodiments of the present invention are intended to include or otherwise cover any type of the compilation of the content 1304, including known, related art, and/or later developed technologies.

In some embodiments of the present invention, the user interface 206 may be displayed in a web application 1306 on the computing device 202. The web application 1306 may be installed on one or more of the computing device 202 selected from a desktop computer, a mobile device, a mobile device, a television, a virtual reality device, a wearable device, or on a standalone device in an organizational intranet, and so forth.

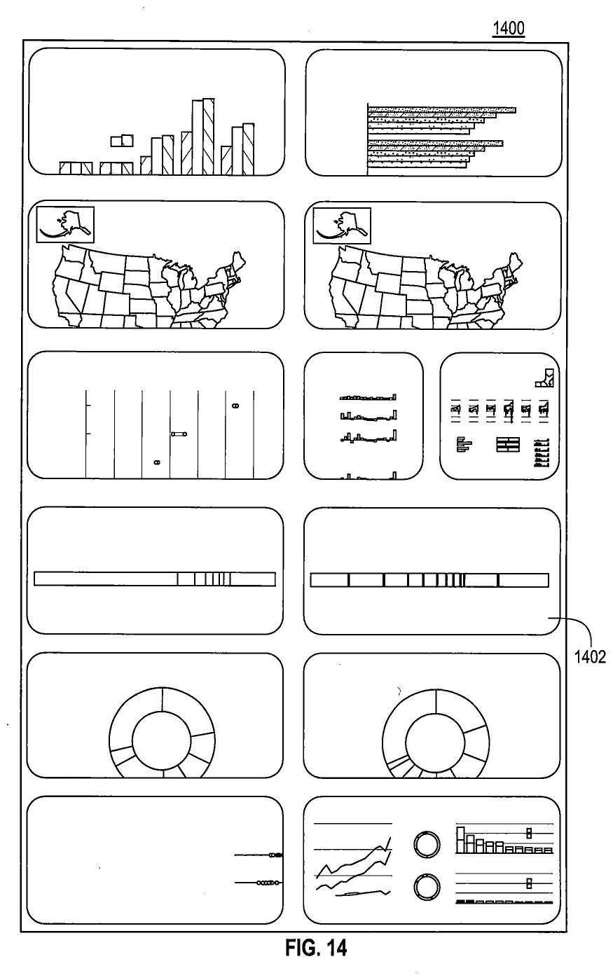

FIG. 14 illustrates the user interface 1400 with the information-rich graphics 1402, according to another exemplary embodiment of the present invention. In an embodiment of the present invention, the user interface 206 may be displayed for the user on the computer application 204. The computer application 204 may represent the information-rich graphics 1402 such that each piece of information-rich graphics 1402 may be a data visualization, cartographic, or diagrammatic component. In one embodiment of the present invention, the user interface 1400 of the computer application 204 may be used to display the results of the search query. In other embodiments of the present invention, the user interface 1400 on the computer application 204 may be used to display the items associated with a particular user and/or a group of the users and/or a particular organization and/or a group of organizations.

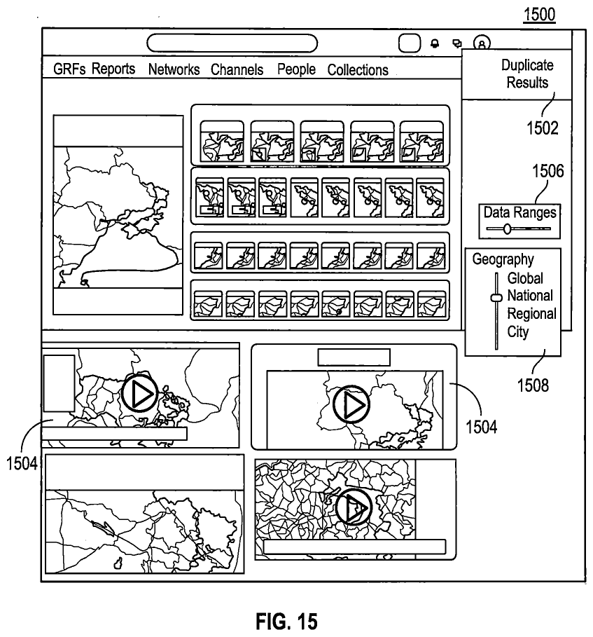

FIG. 15 illustrates the user interface 1500 of the system 200 to retrieve information, according to an exemplary embodiment of the present invention. In an embodiment of the present invention, near duplicates may be clustered in a related or duplicate results section 1502, providing an indication of the density of information from specific sources over time. The computer application 204, utilized within the system 200, may incorporate a rich collection of information-rich graphics 1504 and text, which the users may have the option to preview before visiting the corresponding web location. In an embodiment of the present invention, the users may receive awareness regarding certain interactive or video-based information-rich graphics 1504. These graphics may be accompanied by screenshots, offering a preview of their interactive features. Furthermore, the provenance of the data presented within the information-rich graphics 1504 may be explicitly highlighted, with references to underlying data sources 208 and the original publishers of the graphics.

To enhance the user's experience in navigating and interacting with the search results, various visual aids may be provided in different embodiments of the present invention. For instance, a toggle bar for date 1506 may be available, enabling the users to filter the results based on specific timeframes. Similarly, a toggle bar for geographical area 1508 may be provided, enabling the users to narrow down the search results based on geographic regions or scope of geographic view. These embodiments emphasize the potential enhancements offered by the present invention, where near duplicates are clustered, information-rich graphics 1504 and overlaid text may be previewed together, the users are informed about interactive or video-based graphics as well as static graphics, and visual aids are provided for refining search result navigation. The incorporation of these features may contribute to a more intuitive, efficient, and informative user interface within the system 200.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation, or technique.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to the system for locating, cataloguing, and displaying information-rich graphics. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for locating, cataloguing, and displaying information-rich graphics, the system comprising:
one or more computing devices, wherein the one or more computing devices are configured with at least one computer application;
at least one user interface established in the one or more computing devices using the at least one computer application;
at least one storage medium, coupled to at least one processor, the at least one storage medium comprising one or more executable by the at least one processor, wherein the one or more instructions enable the system to:
receive one or more user inputs from at least one of the one or more computing devices;
parse, using a machine learning algorithm, the one or more inputs to identify one or more textual content, one or more media content, or a combination thereof;
fetch one or more content attributes from a plurality of data sources based on the identified one or more textual content, the one or more media content, or a combination thereof;
analyze the fetched one or more content attributes to catalogue the one or more content attributes into one or more categories;
classify each of the catalogued content attributes into at least one dataset based on at least one score;
generate one or more information-rich graphics by encoding the at least one classified content attributes into a multimodal embedding; and
display the one or more generated information-rich graphics on the at least one user interface established in the one or more computing device using the at least one computer application.

2. The system of claim 1, wherein the one or more instructions further enable the system to retrieve a contextual understanding based on the one or more user inputs.

3. The system of claim 1, wherein the one or more fetched content attributes are catalogued for conducting a nearest neighbor search to perform at least one action on the one or more fetched content attributes.

4. The system of claim 1, wherein the at least one score is generated for each of the classified content attributes based on at least one characteristic of the classified content attributes.

5. The system of claim 1, wherein the multimodal embeddings are generated by encoding the content attributes into a high-dimensional vector space.

6. The system of claim 1, wherein the multimodal embedding enables a placement of the one or more classified content attributes with associated one or more meta-information.

7. The system of claim 6, wherein the meta-information is selected from a title, a caption, a description, a publisher, a data source, a metrics, a legend, or a combination thereof.

8. The system of claim 1, wherein the one or more instructions further enable the system to sub-classify the one or more user inputs, the one or more media content, the one or more textual content, the at least one content attribute, or a combination thereof, into one of an eligible class or an ineligible class.

9. The system of claim 8, wherein the sub-classified one or more user inputs, the one or more media content, the one or more textual content, the at least one content attribute, or a combination thereof into the eligible class are used for the generation of the one or more information-rich graphics.

10. The system of claim 1, wherein the one or more instructions further enable the system to enable the user to select one of the displayed one or more multimodal catalogued information-rich graphics.

11. A system for locating, cataloguing, and displaying information-rich graphics, the system comprising:
one or more computing devices, wherein the one or more computing devices are configured with at least one computer application;
at least one user interface established in the one or more computing devices using the at least one computer application;
at least one storage medium, coupled to at least one processor, the at least one storage medium comprising one or more executable by the at least one processor, wherein the one or more instructions enable the system to:
receive one or more user inputs from at least one of the one or more computing devices;
parse, using a machine learning algorithm, the one or more inputs to identify one or more textual content, one or more media content, or a combination thereof;
fetch one or more content attributes from a plurality of data sources based on the identified one or more textual content, the one or more media content, or a combination thereof;
analyze the fetched one or more content attributes to catalogue the one or more content attributes into one or more categories, wherein the one or more fetched content attributes are catalogued for conducting a nearest neighbor search to perform at least one action on the one or more fetched content attributes;
classify each of the catalogued content attributes into at least one dataset based on at least one score;
generate one or more information-rich graphics by encoding the at least one classified content attributes into a multimodal embedding; and
display the one or more generated information-rich graphics on the at least one user interface established in the one or more computing device using the at least one computer application.

12. The system of claim 11, wherein the at least one score is generated for each of the classified content attributes based on at least one characteristic of the classified content attributes.

13. The system of claim 11, wherein the multimodal embeddings are generated by encoding the content attributes into a high-dimensional vector space.

14. The system of claim 11, wherein the multimodal embeddings enables a placement of the one or more classified content attributes with associated one or more meta-information.

15. The system of claim 14, wherein the meta information is selected from a title, a caption, a description, a publisher, a data source, a metrics, a legend, or a combination thereof.

16. The system of claim 11, wherein the one or more instructions further enable the system to sub-classify the one or more user inputs, the one or more media content, the one or more textual content, the at least one content attribute, or a combination thereof, into one of an eligible class or an ineligible class.

17. The system of claim 16, wherein the sub-classified one or more user inputs, the one or more media content, the one or more textual content, the at least one content attribute, or a combination thereof into the eligible class are used for the generation of the one or more information-rich graphics.

18. A method for locating, cataloguing, and displaying information-rich graphics, the method comprising steps of:
receiving one or more user inputs from at least one of the one or more computing devices;
parsing, using a machine learning algorithm, the one or more inputs to identify one or more textual content, one or more media content, or a combination thereof;
fetching one or more content attributes from a plurality of data sources based on the identified one or more textual content, the one or more media content, or a combination thereof;
analyzing the fetched one or more content attributes to catalogue the one or more content attributes into one or more categories;
classifying each of the catalogued content attributes into at least one dataset based on at least one score;
generating one or more information-rich graphics by encoding the at least one classified content attributes into a multimodal embedding; and
display the one or more generated information-rich graphics on the at least one user interface established in the one or more computing device using the at least one computer application.

19. The method of claim 18, further comprise a step of saving the one or more displayed information-rich graphics on the one or more computing device using the at least one computer application.

20. The method of claim 18, wherein the multimodal embeddings are generated by encoding the content attributes into a high-dimensional vector space.
